(19) United States
(12) Patent Application Publication
(10) Pub. No.: US 2023/0195988 A1
(43) Pub. Date: Jun. 22, 2023

(54) SUPERCONDUCTING QUANTUM CHIP

(71) Applicant: BEIJING BAIDU NETCOM SCIENCE TECHNOLOGY CO., LTD., Beijing (CN)

(72) Inventors: Kehui YU, Beijing (CN); Lijing Jin, Beijing (CN)

(73) Assignee: BEIJING BAIDU NETCOM SCIENCE TECHNOLOGY CO., LTD., Beijng (CN)

(21) Appl. No.: 18/108,585

(22) Filed: Feb. 11, 2023

(30) Foreign Application Priority Data
Feb. 11, 2022 (CN) 202210129160.0

(51) Int. Cl. G06F 30/39; G06N 10/00

(52) U.S. Cl. CPC G06F 30/39; G06N 10/00

(57) ABSTRACT

A method is provided. The method includes: obtaining a parameter value of a determined dimension parameter, an initial parameter value of a dimension parameter to be optimized, and a target capacitance value of an interdigital capacitor; partitioning a geometric structure of the interdigital capacitor to obtain a plurality of sections of the interdigital capacitor, where the plurality of sections are in a one-to-one correspondence with a plurality of coplanar multiple-transmission line models; obtaining a capacitance value expression of the interdigital capacitor based on the plurality of coplanar multiple-transmission line models; determining, based on the parameter value of the determined dimension parameter, the target capacitance value, and the capacitance value expression of the interdigital capacitor, a loss function including the dimension parameter to be optimized; and optimizing, based on the initial parameter value by minimizing the loss function, the parameter value of the dimension parameter to be optimized.

### CROSS REFERENCE TO RELATED APPLICATIONS

The present application claims priority to Chinese Patent Application No. 202210129160.0 filed on Feb. 11, 2022, the content of which is hereby incorporated by reference in its entirety for all purposes.

### TECHNICAL FIELD

The present disclosure relates to the field of quantum computers, in particular to the field of quantum chip design technologies, and specifically to a method and apparatus for designing a superconducting quantum chip, an electronic device, a computer-readable storage medium, and a computer program product.

### BACKGROUND

In recent years, quantum computing has become an important direction for research and development in both academia and industry. Quantum computing has shown significant advantages over traditional computing in solving problems such as the decomposition of large prime numbers. In addition, quantum computing is also of great significance to cutting-edge research such as quantum many-body systems and quantum chemistry simulations. In terms of hardware implementation, quantum computing currently has a variety of technical solutions, such as superconducting circuits, ion traps, photons, and neutral atoms. Among them, superconducting circuit systems based on superconducting Josephson junctions, due to their advantages of long decoherence time, easy manipulation and reading, and high scalability, are considered to be the most promising hardware candidates for quantum computing in the industry. As the physical implementation of superconducting quantum systems, the design, development, and fabrication of superconducting quantum chips integrating multiple qubits are of great significance.

### SUMMARY

The present disclosure provides a method and apparatus for designing a superconducting quantum chip, an electronic device, a computer-readable storage medium, and a computer program product.

According to one aspect of the present disclosure, there is provided a method for designing a superconducting quantum chip including an interdigital capacitor, the method including: obtaining a parameter value of a determined dimension parameter, an initial parameter value of a dimension parameter to be optimized, and a target capacitance value of the interdigital capacitor; partitioning a geometric structure of the interdigital capacitor to obtain a plurality of sections of the interdigital capacitor, where the plurality of sections are in a one-to-one correspondence with a plurality of coplanar multiple-transmission line models; obtaining a capacitance value expression of the interdigital capacitor based on the plurality of coplanar multiple-transmission line models; determining, based on the parameter value of the determined dimension parameter, the target capacitance value of the interdigital capacitor, and the capacitance value expression of the interdigital capacitor, a loss function including the dimension parameter to be optimized; and optimizing, based on the initial parameter value of the dimension parameter and by minimizing the loss function, the parameter value of the dimension parameter to be optimized, so as to obtain an optimized parameter value of the dimension parameter to be optimized.

According to another aspect of the present disclosure, there is provided an electronic device, including a memory storing one or more programs configured to be executed by one or more processors, the one or more programs including instructions for causing the electronic device to perform operations comprising: obtaining a parameter value of a determined dimension parameter, an initial parameter value of a dimension parameter to be optimized, and a target capacitance value of the interdigital capacitor; partitioning a geometric structure of the interdigital capacitor to obtain a plurality of sections of the interdigital capacitor, wherein the plurality of sections are in a one-to-one correspondence with a plurality of coplanar multiple-transmission line models; obtaining a capacitance value expression of the interdigital capacitor based on the plurality of coplanar multiple-transmission line models; determining, based on the parameter value of the determined dimension parameter, the target capacitance value of the interdigital capacitor, and the capacitance value expression of the interdigital capacitor, a loss function including the dimension parameter to be optimized; and optimizing, based on the initial parameter value of the dimension parameter and by minimizing the loss function, the parameter value of the dimension parameter to be optimized, to obtain an optimized parameter value of the dimension parameter to be optimized.

According to another aspect of the present disclosure, there is provided a non-transitory computer-readable storage medium that stores one or more programs comprising instructions that, when executed by one or more processors of a computing device, cause the computing device to implement operations comprising: obtaining a parameter value of a determined dimension parameter, an initial parameter value of a dimension parameter to be optimized, and a target capacitance value of the interdigital capacitor; partitioning a geometric structure of the interdigital capacitor to obtain a plurality of sections of the interdigital capacitor, wherein the plurality of sections are in a one-to-one correspondence with a plurality of coplanar multiple-transmission line models; obtaining a capacitance value expression of the interdigital capacitor based on the plurality of coplanar multiple-transmission line models; determining, based on the parameter value of the determined dimension parameter, the target capacitance value of the interdigital capacitor, and the capacitance value expression of the interdigital capacitor, a loss function including the dimension parameter to be optimized; and optimizing, based on the initial parameter value of the dimension parameter and by minimizing the loss function, the parameter value of the dimension parameter to be optimized, to obtain an optimized parameter value of the dimension parameter to be optimized.

It should be understood that the content described in this section is not intended to identify critical or important features of the embodiments of the present disclosure, and is not used to limit the scope of the present disclosure either. Other features of the present disclosure will be easily understood through the following description.

### BRIEF DESCRIPTION OF THE DRAWINGS

The accompanying drawings show embodiments and form a part of the specification, and are used to explain implementations of the embodiments together with a written description of the specification. The embodiments shown are merely for illustrative purposes and do not limit the scope of the claims. Throughout the accompanying drawings, the same reference numerals denote similar but not necessarily same elements.

FIG. 1 is a schematic diagram of an exemplary system in which various methods described herein can be implemented according to an embodiment of the present disclosure;

FIG. 2 is a flowchart of a method for designing a superconducting quantum chip according to an embodiment of the present disclosure;

FIG. 3 is a schematic structural diagram of an interdigital capacitor according to an embodiment of the present disclosure;

FIG. 4 is a schematic diagram of partitioning a geometric structure of the interdigital capacitor shown in FIG. 3 according to an embodiment of the present disclosure;

FIG. 5 is a schematic diagram of a coplanar multiple transmission line model according to an embodiment of the present disclosure;

FIG. 6 is a schematic cross-sectional view of the coplanar multiple transmission line model shown in FIG. 5;

FIG. 7a and FIG. 7b are respectively schematic diagrams of a complex plane before and after a conformal transformation of an upper half-plane of a metal conductor shown in FIG. 6;

FIG. 8 is a schematic diagram of a comparison between results of a finite element numerical simulation method and a method according to an embodiment of the present disclosure;

FIG. 9 is a schematic diagram of relative errors between a finite element numerical simulation method and a method according to an embodiment of the present disclosure;

FIG. 10 is a structural block diagram of a apparatus for designing a superconducting quantum chip according to an embodiment of the present disclosure; and

FIG. 11 is a structural block diagram of an exemplary electronic device that can be used to implement an embodiment of the present disclosure.

### DETAILED DESCRIPTION OF EMBODIMENTS

Embodiments of the present disclosure are described below with reference to the accompanying drawings, where various details of the embodiments of the present disclosure are included for a better understanding, and should be considered as merely example. Therefore, those of ordinary skill in the art should be aware that various changes and modifications can be made to the embodiments described herein, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one component from another. In some examples, the first element and the second element may refer to the same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed items.

The embodiments of the present disclosure will be described below in detail with reference to the accompanying drawings.

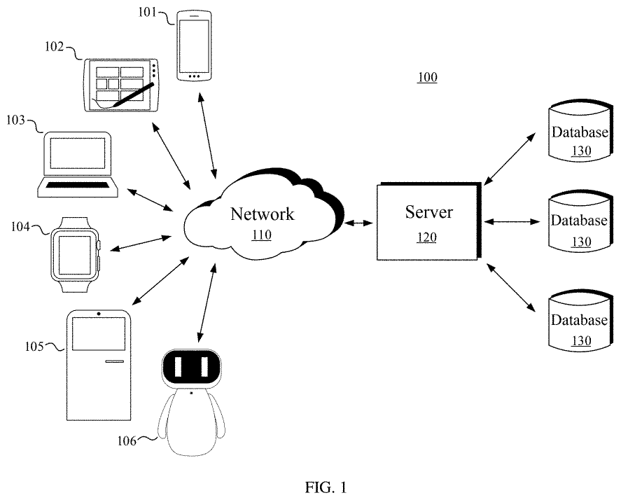

FIG. 1 is a schematic diagram of an system 100 in which various methods and apparatuses described herein can be implemented according to an embodiment of the present disclosure. Referring to FIG. 1, the system 100 includes one or more client devices 101, 102, 103, 104, 105, and 106, a server 120, and one or more communications networks 110 that couple the one or more client devices to the server 120. The client devices 101, 102, 103, 104, 105, and 106 may be configured to execute one or more application programs.

In an embodiment of the present disclosure, the server 120 can run one or more services or software applications that enable a design method for a superconducting quantum chip to be performed.

In some embodiments, the server 120 may further provide other services or software applications that may include a non-virtual environment and a virtual environment. In some embodiments, these services may be provided as web-based services or cloud services, for example, provided to a user of the client device 101, 102, 103, 104, 105, and/or 106 in a software as a service (SaaS) model.

In the configuration shown in FIG. 1, the server 120 may include one or more components that implement functions performed by the server 120. These components may include software components, hardware components, or a combination thereof that can be executed by one or more processors. A user operating the client device 101, 102, 103, 104, 105, and/or 106 may sequentially use one or more client application programs to interact with the server 120, thereby utilizing the services provided by these components. It should be understood that various system configurations are possible, which may be different from the system 100. Therefore, FIG. 1 is an example of the system for implementing various methods described herein, and is not intended to be limiting.

The user may use the client device 101, 102, 103, 104, 105, and/or 106 to determine corresponding dimension parameters, etc. The client device may provide an interface that enables the user of the client device to interact with the client device. The client device may also output information to the user via the interface. Although FIG. 1 depicts only six types of client devices, those skilled in the art will understand that any number of client devices are possible in the present disclosure.

The client device 101, 102, 103, 104, 105, and/or 106 may include various types of computer devices, such as a portable handheld device, a general-purpose computer (such as a personal computer and a laptop computer), a workstation computer, a wearable device, a smart screen device, a self-service terminal device, a service robot, a gaming system, a thin client, various messaging devices, and a sensor or other sensing devices. These computer devices can run various types and versions of software application programs and operating systems, such as MICROSOFT Windows, APPLE iOS, a UNIX-like operating system, and a Linux or Linux-like operating system (e.g., GOOGLE Chrome OS); or include various mobile operating systems, such as MICROSOFT Windows Mobile OS, iOS, Windows Phone, and Android. The portable handheld device may include a cellular phone, a smartphone, a tablet computer, a personal digital assistant (PDA), etc. The wearable device may include a head-mounted display (such as smart glasses) and other devices. The gaming system may include various handheld gaming devices, Internet-enabled gaming devices, etc. The client device can execute various application programs, such as various Internet-related application programs, communication application programs (e.g., email application programs), and short message service (SMS) application programs, and can use various communication protocols.

The network 110 may be any type of network well known to those skilled in the art, and it may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a public switched telephone network (PSTN), an infrared network, a wireless network (such as Bluetooth or Wi-Fi), and/or any combination of these and/or other networks.

The server 120 may include one or more general-purpose computers, a dedicated server computer (e.g., a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures relating to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any of the above-mentioned operating systems and any commercially available server operating system. The server 120 can also run any one of various additional server application programs and/or middle-tier application programs, including an HTTP server, an FTP server, a CGI server, a JAVA server, a database server, etc.

In some implementations, the server 120 may include one or more application programs to analyze and merge data feeds and/or event updates received from users of the client devices 101, 102, 103, 104, 105, and 106. The server 120 may further include one or more application programs to display the data feeds and/or real-time events via one or more display devices of the client devices 101, 102, 103, 104, 105, and 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 may further include one or more databases 130. In some embodiments, these databases can be used to store data and other information. For example, one or more of the databases 130 can be used to store information such as a parameter value and a capacitance value expression. The databases 130 may reside in various locations. For example, a database used by the server 120 may be locally in the server 120, or may be remote from the server 120 and may communicate with the server 120 via a network-based or dedicated connection. The databases 130 may be of different types. In some embodiments, the database used by the server 120 may be, for example, a relational database. One or more of these databases can store, update, and retrieve data from or to the database, in response to a command.

In some embodiments, one or more of the databases 130 may also be used by an application program to store application program data. The database used by the application program may be of different types, for example, may be a key-value repository, an object repository, or a regular repository backed by a file system.

The system 100 of FIG. 1 may be configured and operated in various manners, such that the various methods and apparatuses described according to the present disclosure can be applied.

With the rapid development of the quantum computing industry, IBM, Regetti and other companies have released their quantum roadmaps, and in the foreseeable future, there will be superconducting quantum chips with hundreds or even millions of qubits. The research and development of such a large-scale superconducting quantum chip lead to an increase in the difficulty of chip design. Therefore, the design efficiency of the superconducting quantum chip will become a key issue.

The design of the superconducting quantum chip mainly includes two parts: the design of individual elements and the design of coupling between elements. The design of individual elements relates mainly to the design of geometric dimensions of element structures such as a qubit, a coupler, and a resonator, to meet desired characteristic parameters such as eigenfrequency, anharmonicity, and quality factor. The design of individual elements determines static characteristic parameters of the quantum chip. In addition, it is also required to perform operations, such as control and read, on the superconducting quantum chip, which are mainly implemented through coupling. The design of coupling directly affects the performance of the superconducting quantum chip. In the superconducting quantum chip, to protect a qubit, the read function is mainly implemented by performing an indirect non-destructive measurement through coupling between the qubit and the resonator. An interdigital capacitor, a type of capacitor formed by interdigitating metal conductors, is often used as a coupling capacitor for the resonator and the qubit. Therefore, an efficient design of the interdigital capacitor is crucial for the performance of the entire superconducting quantum chip.

Currently, the industry for the design of superconducting quantum chips mainly relies on the experience of designers to manually design a geometric layout. To obtain a desired capacitance parameter, a plurality of simulations and manual iterations of geometric parameters are required to obtain the final design. For example, a common method is to use finite element software for simulation. A designer manually draws the first draft of the layout according to requirements for the coupling capacitor and based on empirical parameters, and then constantly adjusts the geometric parameters and performs a large number of repeated simulations until the design parameter requirements of the capacitor are met. This method requires researchers to know a rough geometric dimension in advance through experience, and repeatedly manually adjust based on the dimension for simulation to meet the design requirements. Such a design method requires designers to perform a lot of repetitive work. This consumes a lot of time and energy and is inefficient, and therefore the degree of automation is low and human resources are excessively consumed. Moreover, such a design method relies excessively on the experimental experience of researchers, which has a great uncertainty and heavily depends on the selection of empirical parameters. Facing the growing scale of superconducting quantum chips, the industry needs more efficient design solutions.

Coupling between different elements in a superconducting quantum chip determines the control and read performance of the quantum chip. The coupling includes coupling between qubits, coupling between a qubit and a resonator, and coupling between control ports. For example, the interdigital capacitor can be used to read coupling between the resonator and an Xmon qubit. Coupling strength directly depends on dimensions of the interdigital capacitor, and therefore a precise design of the interdigital capacitor is crucial to the performance of the quantum chip.

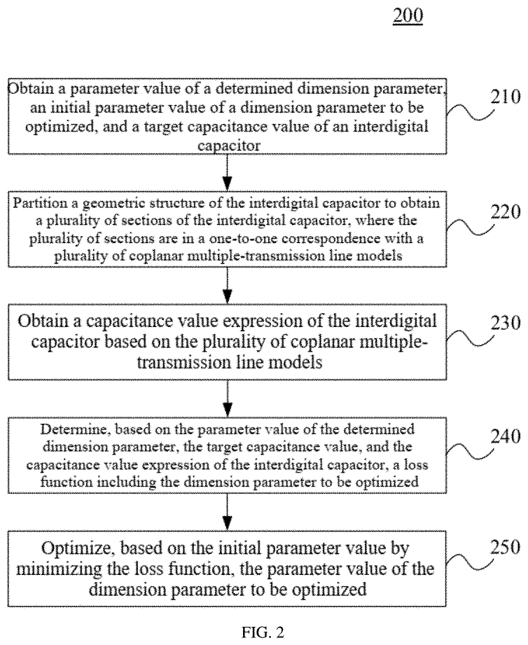

Therefore, according to an embodiment of the present disclosure, a method for a designing superconducting quantum chip including an interdigital capacitor is provided. As shown in FIG. 2, a method 200 may include: obtaining a parameter value of a determined dimension parameters, an initial parameter value of a dimension parameter to be optimized, and a target capacitance value of an interdigital capacitor (step 210); partitioning a geometric structure of the interdigital capacitor to obtain a plurality of sections of the interdigital capacitor, where the plurality of sections are in a one-to-one correspondence with a plurality of coplanar multiple-transmission line models (step 220); obtaining a capacitance value expression of the interdigital capacitor based on the plurality of coplanar multiple-transmission line models (step 230); determining, based on the parameter value of the determined dimension parameter, the target capacitance value, and the capacitance value expression of the interdigital capacitor, a loss function including the dimension parameter to be optimized (step 240); and optimizing, based on the initial parameter value by minimizing the loss function, the parameter value of the dimension parameter to be optimized, so as to obtain an optimized parameter value of the dimension parameter to be optimized (step 250).

According to this embodiment of the present disclosure, a simple and efficient capacitance solution model is obtained by partitioning the geometric structure of the interdigital capacitor of the superconducting quantum chip, so as to directly obtain the optimized geometric dimension of the interdigital capacitor through algorithm optimization based on the target capacitance, which no longer requires a lot of repetitive work by designers and can greatly improve the design efficiency of the superconducting quantum chip.

In a fabrication process of a superconducting quantum chip, a metal layer is deposited on a substrate, and the metal layer is etched to form an interdigital capacitor having a specific structure. In some embodiments, a coupling capacitance expression of the interdigital capacitor in the superconducting quantum chip may first be determined, where the expression includes several dimension parameters.

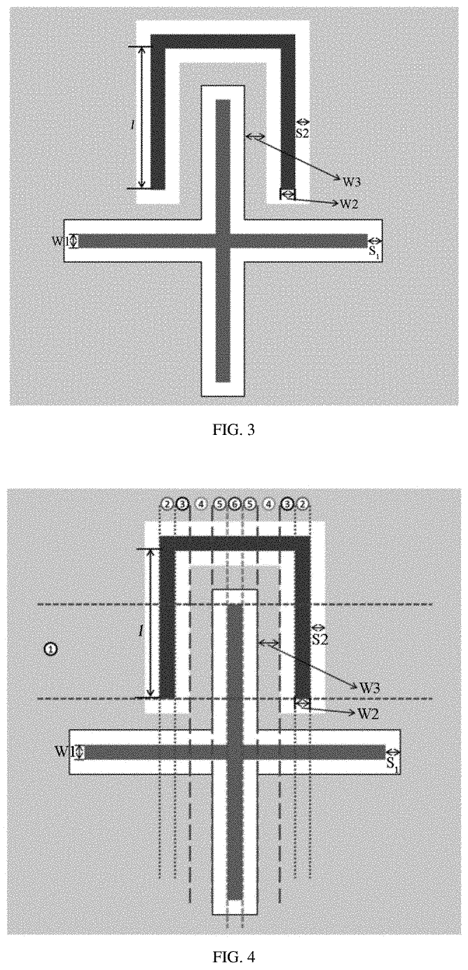

FIG. 3 is a schematic structural diagram of an interdigital capacitor according to an exemplary embodiment. As shown in FIG. 3, the interdigital capacitor includes a U-shaped structure and a cross-shaped structure, with one end of the cross-shaped structure inserted into a groove of the U-shaped structure. For example, the cross-shaped structure (in dark gray) may be a center conductor of an Xmon qubit, and its conductor width is w₁; the U-shaped structure (in black) is part of the interdigital capacitor, and a width of its center conductor is w₂; a distance between the U-shaped structure and the cross-shaped structure is w₃ (left, right, and upper distances are usually all equal to w₃); In addition to the cross-shaped structure and the U-shaped structure, there is a grounded conductor in light gray (having a potential of zero); parts in white are gaps formed after metal etching and have widths of s₁ and s₂, respectively; and a finger length of the interdigital capacitor is 1.

Generally, the design of the superconducting quantum chip includes the design of individual elements and the design of coupling between elements. Usually, geometric dimensions of an individual element have been determined in the static characteristic parameter design (which is a preamble step for the coupling design). Therefore, during implementation of the coupling design using the interdigital capacitor, all the geometric parameters of the cross-shaped structure shown in FIG. 3 have been determined; the U-shaped structure is often connected to a read resonator, and the conductor width and the gap width of the U-shaped structure have also been determined. In other words, w₁, w₂, s₁, and s₂ shown in FIG. 3 are all determined values.

Moreover, the distance w₃ between the U-shaped structure and the cross-shaped structure has less impact on the design of the superconducting quantum chip than the finger length L. Therefore, in some embodiments, w₃ can also be set to a determined value (a common empirical parameter). Then, the most critical geometric degree of freedom that affects the coupling capacitance of the interdigital capacitor is the finger length l. In other words, in this case, the finger length l needs to be designed based on a value of a desired coupling capacitance C.

According to some embodiments, the determined dimension parameter of the interdigital capacitor may include: the width (w₂) of the center conductor of the U-shaped structure, the width (w₁) of the center conductor of the cross-shaped structure, the distance (w₃) between the U-shaped structure and the end of the cross-shaped structure inserted into the U-shaped structure, and the respective etching widths (s₁ and s₂) used to form the U-shaped structure and the cross-shaped structure through etching. The dimension parameter to be optimized of the interdigital capacitor may include: a depth of the groove of the U-shaped structure (i.e., the finger length l).

The structure of the interdigital capacitor is so complex that the capacitance value cannot be directly calculated. Therefore, the geometric structure of the interdigital capacitor may be partitioned to establish a model that is easy to solve.

According to some embodiments, the plurality of sections of the interdigital capacitor may be obtained by partitioning the geometric structure of the interdigital capacitor along a first direction and a direction vertical to the first direction. The first direction is vertical to an extension direction of the end of the cross-shaped structure inserted into the groove of the U-shaped structure. In other words, the geometric structure of the interdigital capacitor may be partitioned along horizontal and vertical directions of a plane shown in FIG. 3.

FIG. 4 is a schematic diagram of partitioning a geometric structure of the interdigital capacitor according to an embodiment of the present disclosure. As shown in FIG. 4, to facilitate calculation of mutual capacitance between the center conductor (the part of the cross-shaped structure) of the Xmon qubit and the center conductor of the U-shaped finger part, the geometric structure of the interdigital capacitor is partitioned into six sections along the horizontal and vertical directions, and each of these sections may be considered as a coplanar multiple transmission line model as shown in FIG. 5. Two metal segments A and B in FIG. 5 may be considered as the center conductor of the U-shaped structure and the center conductor of the Xmon qubit, respectively, and the mutual capacitance between A and B is the coupling capacitance.

Still referring to FIG. 4, each section obtained by partitioning the geometric structure of the interdigital capacitor is numbered, and the coupling capacitance of each section is in a parallel relationship with another. Therefore, the coupling capacitance of the entire interdigital capacitor can be obtained by solving the coupling capacitance of each section. It should be noted that regions having the same number in FIG. 4 have the same structure, and a capacitance value of only one of the regions needs to be calculated and then multiplied by the number of the same regions. Finally, a total coupling capacitance is obtained by summation, as shown in formula (1):

Cₜₒₜₐₗ=2(C₁+C₂+C₃+C₄+C₅)+C₆ formula (1)

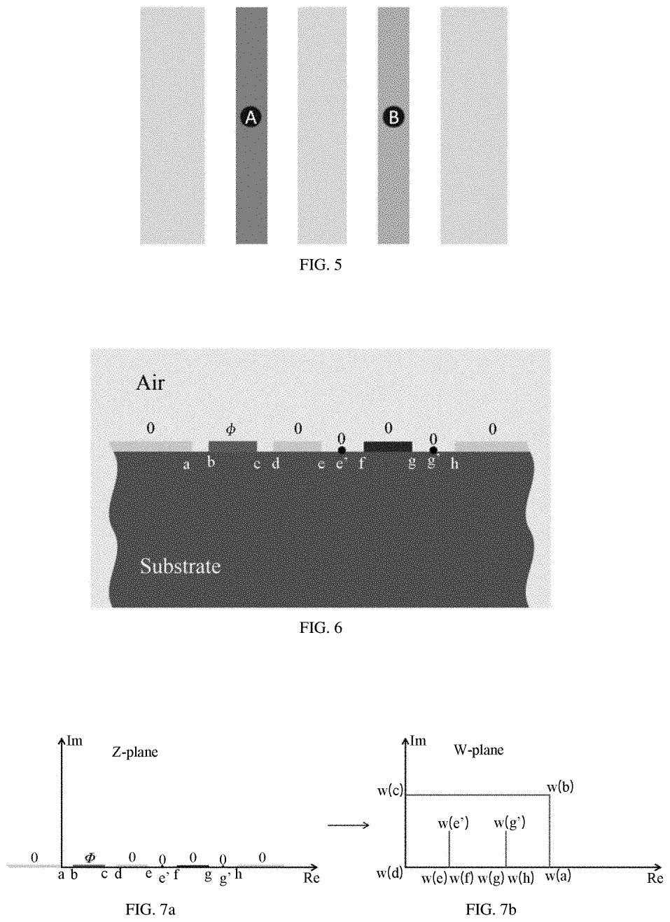

To calculate the coupling capacitance of the coplanar multiple transmission line model shown in FIG. 5, FIG. 6 is a schematic cross-sectional view of the multiple transmission line model along a direction perpendicular to the plane shown in FIG. 5. As shown in FIG. 6, the schematic cross-sectional view includes an air layer, a metal layer, and a substrate successively from top to bottom. The metal layer includes a grounded conductor, a conductor A, the grounded conductor, a conductor B, and the grounded conductor successively from left to right, and a region between two metal conductors is a gap after etching. For this model, to facilitate the calculation of the coupling capacitance, the following assumptions may be made:

(1) A thickness of the metal layer is much less than that of the substrate and can be ignored. Therefore, in this model, the thickness of the metal layer is considered to be infinitely small, and the thickness of the substrate infinitely large.

(2) A width of a transmission line is much less than a length of the transmission line, and it can be considered that the transmission line is infinitely long and even. Therefore, capacitance per unit length along the direction of the transmission line is equal everywhere. As shown in formula (2), the total capacitance can be determined by multiplying the capacitance C₀ per unit length by the length h of the transmission line.

C=C₀h formula (2)

It should be noted that after the section numbered \textcircled{2} in FIG. 4 is converted into the multiple transmission line model shown in FIG. 5, a width of its transmission line is much greater than a length of the transmission line, but the contribution of this section to the total coupling capacitance is much less than that of other sections. Therefore, for the convenience of calculation, the width of the transmission line for this section can also be approximated as much less than the length of the transmission line.

As shown in FIG. 6, the mutual capacitance C₀ per unit length is calculated based on a cross section of the multiple transmission line model. Before the calculation of the mutual capacitance, it can be first assumed that a potential of the conductor A is unknown φ, and that potentials of the remaining conductors are all 0. Because potentials of two adjacent conductors are equal and both are 0, there is definitely a point between the two conductors at which a potential is 0, e.g., a point e′ and a point g′ shown in FIG. 6.

The metal conductors are all thin coplanar structures, and an electromagnetic field is mainly distributed in upper and lower spaces. Therefore, such a structure is relatively difficult to solve. For this problem, based on a mathematical method of conformal transformation, such a coplanar structure that is difficult to solve can be transformed into a parallel plate capacitor-like structure that is easy to solve, so that its capacitance can be directly calculated.

First, an upper half-plane may be selected for modeling calculation. A modeling method is shown in FIG. 7a. Two-dimensional spatial coordinates are modeled as a real part and an imaginary part of a complex plane, where the real part corresponds to the tangential direction of the surface of the metal layer, and the imaginary part corresponds to the normal direction of the surface of the metal layer. The upper half-space of the original Z plane is transformed into a finite rectangular region of the W plane using the Shwarz-Christoffel transformation shown in formula (3).

$$w ( z ) = {\int }_{0}^{{z}^{′}} \frac{( {z}^{′} - {z}_{{e}^{′}} ) ( {z}^{′} - {z}_{{g}^{′}} )}{\begin{matrix}( {z}^{′} - {z}_{a} ) ( {z}^{′} - {z}_{b} ) ( {z}^{′} - {z}_{c} ) ( {z}^{′} - {z}_{d} ) \\ ( {z}^{′} - {z}_{e} ) ( {z}^{′} - {z}_{f} ) ( {z}^{′} - {z}_{g} ) ( {z}^{′} - {z}_{h} )\end{matrix}} {dz}^{′} \qquad formula ( 3 )$$

The conformal transformation has the following properties: angle preserving, scalability preserving, and unchanged Laplace's equation. Therefore, a transformed space keeps an equipotential surface perpendicular to electric field lines, and boundary conditions are transformed to scale, and still meet the Laplace's equation. It can be concluded from the uniqueness theorem that, a capacitance value solved in the new space is the same as that in the original space. It can be seen from FIG. 7b that the transformed structure is similar to a parallel plate capacitor. From the mathematical principle of the transformation in formula (3), it can be concluded that the imaginary part of the transformed plane just corresponds to the potential. Therefore, capacitance per unit length generated by a conductor be and a conductor fg through the upper half-plane is shown in formula (4):

$${C}_{u p} = {ε}_{0} {ε}_{r} \frac{Re ( w ( g ) ) - Re ( w ( f ) )}{Im ( w ( b ) ) - Im ( w ( a ) )} \qquad formula ( 4 )$$

where ε₀ is an absolute permittivity of air; εᵣ is a relative permittivity of the substrate; and Re( ) and Im( ) represent a real part and an imaginary part in the complex plane, respectively.

The capacitance per unit length of the upper half-plane can be calculated using the conformal transformation technique. A solution method for a lower half-plane is exactly the same as that for the upper half-plane. It is easily seen from the cross-sectional structure in FIG. 6 that capacitance generated by a conductor through the upper half-plane is in a parallel relationship with that generated through the lower half-plane. Therefore, total capacitance per unit length is shown by formula (5):

$${C}_{0} = {C}_{u p} + {C}_{down} = {ε}_{0} ( {ε}_{r} + 1 ) \frac{Re ( w ( g ) ) - Re ( w ( f ) )}{Im ( w ( b ) ) - Im ( w ( a ) )} \qquad formula ( 5 )$$

For example, still referring to FIG. 4, for the section numbered \textcircled{1}, after its capacitance C₀ per unit length is obtained based on the above steps, total capacitance of the section numbered \textcircled{1} can be obtained based on formula (2). Specifically, it can be determined that a conductor length of the section numbered \textcircled{1} is (l-s₁-s₂-w₃). Therefore, the total capacitance of the section numbered \textcircled{1} can be obtained by C₀*(l-s₁-s₂-w₃).

After the above steps, the mutual capacitance between the conductor A and the conductor B in the structure shown in FIG. 5 can be obtained. For each section obtained through partitioning in FIG. 4, its mutual capacitance is successively obtained using the above method, and the capacitance value of each section can be obtained. Then, the result is substituted into formula (1) to obtain the total capacitance value of the interdigital capacitor in the superconducting quantum chip.

In some embodiments, based on the determined geometric structure of the interdigital capacitor in the superconducting quantum chip, a capacitance expression of the interdigital capacitor thereof may be pre-calculated, where the capacitance expression may include one or more dimension parameters. Therefore, after the dimension parameters with known parameter values, the dimension parameter to be optimized, and the target capacitance value are determined, the loss function for optimizing the parameter value of the dimension parameter to be optimized can be obtained based on the capacitance expression. Before optimization, the parameter value of the dimension parameter to be optimized may be initialized, for example, set based on the designer's experience or randomly set, etc., which is not limited herein.

In an exemplary application of the method according to this embodiment of the present disclosure, a calculation result of the method according to this embodiment of the present disclosure is compared with a finite element simulation result (a numerical simulation method commonly used in the industry) to verify the effectiveness of the method according to this embodiment of the present disclosure.

As described above, generally, in the design of the superconducting quantum chip, both the conductor widths and the etching gaps of the cross-shaped structure and the U-shaped structure of the interdigital capacitor have been determined in the design process of an individual device in the preamble step. Therefore, for the design of the interdigital capacitor, a parametric degree of freedom that is usually to be changed is only the finger length l. Therefore, empirical parameters are used to fix the conductor width w₂ of the interdigital capacitor, the ground clearance s₂, the conductor width w₁ of Xmon, the ground clearance s₁, and the distance w₃, and the finger length l is changed to compare the optimization results of the above two methods.

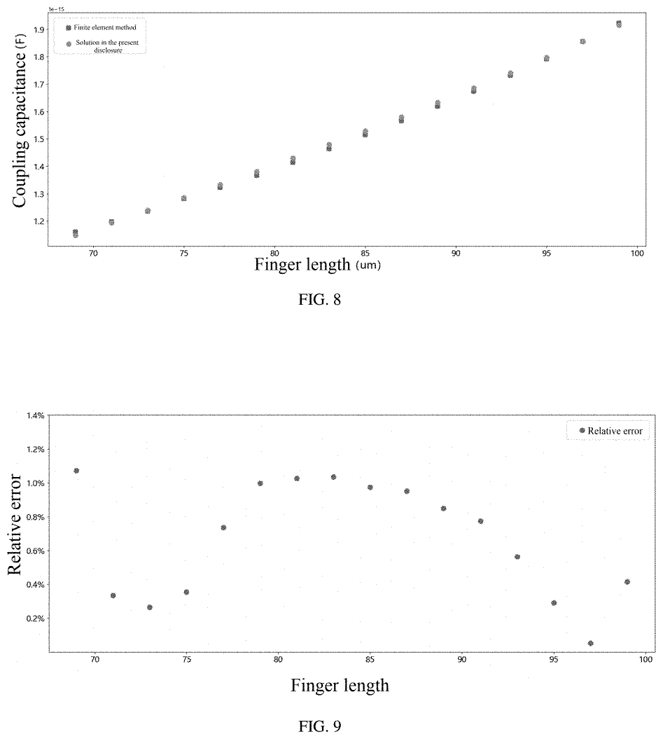

Specifically, the finger length l is set to vary within 65˜100 um, and the comparison between the result of the finite element numerical simulation solution and the result of the solution in this embodiment of the present disclosure is shown in FIG. 8. It can be clearly seen that the results of the two methods are in good agreement. Further, to quantify the effectiveness of the solution of the present invention, a relative error at each data point may further be calculated. Specifically, the relative error=|Result of the solution in the present disclosure−Result of the finite element method|÷Result of the finite element method. As shown in FIG. 9, the relative error between the two solutions does not exceed 1.2%, which fully verifies the accuracy of the result of the solution according to this embodiment of the present disclosure. Moreover, compared with the finite element numerical simulation solution, the solution in this embodiment of the present disclosure greatly improves the efficiency, and no longer requires the designer to manually iterate the geometric parameters, which greatly improves the automation degree of the entire quantum chip design process.

In some embodiments, after the dimension parameter of the interdigital capacitor is optimized, the related dimension parameters of the interdigital capacitor can be determined. Therefore, based on the determined dimension parameters, the center conductor part and another conductor part of the qubit for forming the interdigital capacitor in the superconducting quantum chip are fabricated, so that the coupling between the resonator and the qubit achieves the target coupling effect.

For example, the metal layer is deposited on the provided substrate; and then the metal layer is etched based on the determined dimension parameters to form the interdigital capacitor on the substrate. It can be understood that this is only the most general steps for fabricating the superconducting quantum chip based on the optimized parameter, and other methods are also possible, which are not limited herein.

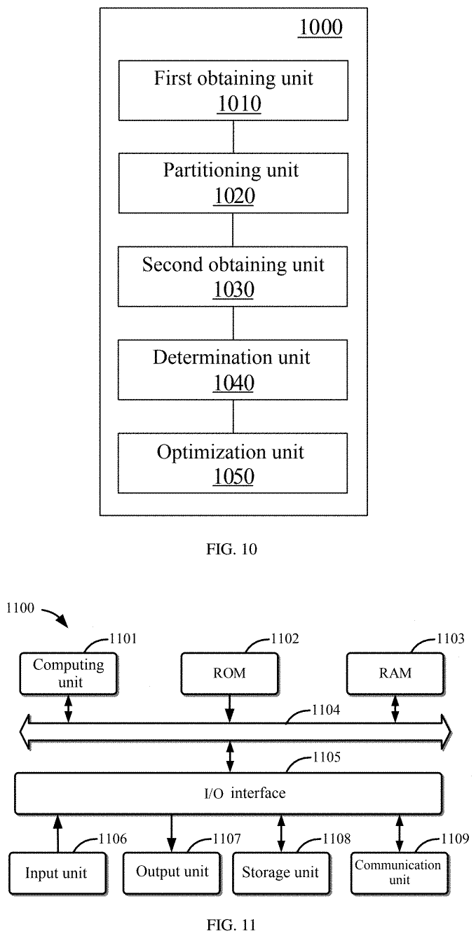

According to an embodiment of the present disclosure, as shown in FIG. 10, there is further provided a design apparatus 1000 for a superconducting quantum chip including an interdigital capacitor, the apparatus including: a first obtaining unit 1010 configured to obtain a parameter value of a determined dimension parameter, an initial parameter value of a dimension parameter to be optimized, and a target capacitance value of the interdigital capacitor; a partitioning unit 1020 configured to partition a geometric structure of the interdigital capacitor to obtain a plurality of sections of the interdigital capacitor, where the plurality of sections are in a one-to-one correspondence with a plurality of coplanar multiple-transmission line models; a second obtaining unit 1030 configured to obtain a capacitance value expression of the interdigital capacitor based on the plurality of coplanar multiple-transmission line models; a determination unit 1040 configured to determine, based on the parameter value of the determined dimension parameter, the target capacitance value of the interdigital capacitor, and the capacitance value expression of the interdigital capacitor, a loss function including the dimension parameter to be optimized; and an optimization unit 1050 configured to optimize, based on the initial parameter value of the dimension parameter and by minimizing the loss function, the parameter value of the dimension parameter to be optimized, so as to obtain an optimized parameter value of the dimension parameter to be optimized.

Herein, the operations of the foregoing units 1010 to 1050 of the design apparatus 1000 for a superconducting quantum chip including an interdigital capacitor are respectively similar to the operations of steps 210 to 250 described above. Details are not repeated herein.

According to the embodiments of the present disclosure, there are further provided an electronic device, a readable storage medium, and a computer program product.

Referring to FIG. 11, a structural block diagram of an electronic device 1100 that can serve as a server or a client of the present disclosure is now described, which is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may also represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 11, the electronic device 1100 includes a computing unit 1101, which may perform various appropriate actions and processing according to a computer program stored in a read-only memory (ROM) 1102 or a computer program loaded from a storage unit 1108 to a random access memory (RAM) 1103. The RAM 1103 may further store various programs and data required for the operation of the electronic device 1100. The computing unit 1101, the ROM 1102, and the RAM 1103 are connected to each other through a bus 1104. An input/output (I/O) interface 1105 is also connected to the bus 1104.

A plurality of components in the electronic device 1100 are connected to the I/O interface 1105, including: an input unit 1106, an output unit 1107, the storage unit 1108, and a communication unit 1109. The input unit 1106 may be any type of device capable of entering information to the electronic device 1100. The input unit 1106 can receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 1107 may be any type of device capable of presenting information, and may include, but is not limited to, a display, a speaker, a video/audio output terminal, a vibrator, and/or a printer. The storage unit 1108 may include, but is not limited to, a magnetic disk and an optical disc. The communication unit 1109 allows the electronic device 1100 to exchange information/data with other devices via a computer network such as the Internet and/or various telecommunications networks, and may include, but is not limited to, a modem, a network interface card, an infrared communication device, a wireless communication transceiver and/or a chipset, e.g., a Bluetooth™ device, an 802.11 device, a Wi-Fi device, a WiMAX device, a cellular communication device, and/or the like.

The computing unit 1101 may be various general-purpose and/or special-purpose processing components with processing and computing capabilities. Some examples of the computing unit 1101 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 1101 performs the various methods and processing described above, for example, the method 200. For example, in some embodiments, the method 200 may be implemented as a computer software program, which is tangibly contained in a machine-readable medium, such as the storage unit 1108. In some embodiments, a part or all of the computer program may be loaded and/or installed onto the electronic device 1100 via the ROM 1102 and/or the communication unit 1109. When the computer program is loaded onto the RAM 1103 and executed by the computing unit 1101, one or more steps of the method 200 described above can be performed. Alternatively, in other embodiments, the computing unit 1101 may be configured, by any other suitable means (for example, by means of firmware), to perform the method 200.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: the systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although the embodiments or examples of the present disclosure have been described with reference to the accompanying drawings, it should be appreciated that the method, system, and device described above are merely exemplary embodiments or examples, and the scope of the present invention is not limited by the embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A computer-implemented method, the method comprising:
obtaining a parameter value of a determined dimension parameter, an initial parameter value of a dimension parameter to be optimized, and a target capacitance value of an interdigital capacitor;
partitioning a geometric structure of the interdigital capacitor to obtain a plurality of sections of the interdigital capacitor, wherein the plurality of sections are in a one-to-one correspondence with a plurality of coplanar multiple-transmission line models;
obtaining a capacitance value expression of the interdigital capacitor based on the plurality of coplanar multiple-transmission line models;
determining, based on the parameter value of the determined dimension parameter, the target capacitance value of the interdigital capacitor, and the capacitance value expression of the interdigital capacitor, a loss function including the dimension parameter to be optimized; and
optimizing, based on the initial parameter value of the dimension parameter and by minimizing the loss function, the parameter value of the dimension parameter to be optimized, to obtain an optimized parameter value of the dimension parameter to be optimized.

2. The method of claim 1, wherein the interdigital capacitor comprises a U-shaped structure and a cross-shaped structure, with an end of the cross-shaped structure inserted into a groove of the U-shaped structure, and wherein
the determined dimension parameter comprises at least one of a width of a center conductor of the U-shaped structure, a width of a center conductor of the cross-shaped structure, a distance between the U-shaped structure and the end of the cross-shaped structure inserted into the U-shaped structure, and respective etching widths for forming the U-shaped structure and the cross-shaped structure through etching; and
the dimension parameter to be optimized comprises a depth of the groove of the U-shaped structure.

3. The method of claim 1, wherein the interdigital capacitor comprises a U-shaped structure and a cross-shaped structure, with an end of the cross-shaped structure inserted into a groove of the U-shaped structure, and wherein
the plurality of sections of the interdigital capacitor are obtained by partitioning the geometric structure of the interdigital capacitor along a first direction and a direction vertical to the first direction, wherein the first direction is vertical to an extension direction of the end of the cross-shaped structure inserted into the groove of the U-shaped structure.

4. The method of claim 1, wherein the parameter value of the dimension parameter to be optimized is optimized using a gradient descent method, to minimize the loss function.

5. The method of claim 1, wherein the capacitance value expression of the interdigital capacitor is obtained by determining respective capacitance values of the plurality of coplanar multiple transmission line models, and wherein the capacitance value of at least one of the plurality of coplanar multiple transmission line models is determined based on a conformal transformation method.

6. An electronic device, comprising:
a memory storing one or more programs configured to be executed by one or more processors, the one or more programs including instructions for causing the electronic device to perform operations comprising:
obtaining a parameter value of a determined dimension parameter, an initial parameter value of a dimension parameter to be optimized, and a target capacitance value of an interdigital capacitor;
partitioning a geometric structure of the interdigital capacitor to obtain a plurality of sections of the interdigital capacitor, wherein the plurality of sections are in a one-to-one correspondence with a plurality of coplanar multiple-transmission line models;
obtaining a capacitance value expression of the interdigital capacitor based on the plurality of coplanar multiple-transmission line models;
determining, based on the parameter value of the determined dimension parameter, the target capacitance value of the interdigital capacitor, and the capacitance value expression of the interdigital capacitor, a loss function including the dimension parameter to be optimized; and
optimizing, based on the initial parameter value of the dimension parameter and by minimizing the loss function, the parameter value of the dimension parameter to be optimized, to obtain an optimized parameter value of the dimension parameter to be optimized.

7. The electronic device of claim 6, wherein the interdigital capacitor comprises a U-shaped structure and a cross-shaped structure, with an end of the cross-shaped structure inserted into a groove of the U-shaped structure, and wherein
the determined dimension parameter comprises at least one of a width of a center conductor of the U-shaped structure, a width of a center conductor of the cross-shaped structure, a distance between the U-shaped structure and the end of the cross-shaped structure inserted into the U-shaped structure, and respective etching widths for forming the U-shaped structure and the cross-shaped structure through etching; and
the dimension parameter to be optimized comprises a depth of the groove of the U-shaped structure.

8. The electronic device of claim 6, wherein the interdigital capacitor comprises a U-shaped structure and a cross-shaped structure, with an end of the cross-shaped structure inserted into a groove of the U-shaped structure, and wherein
the plurality of sections of the interdigital capacitor are obtained by partitioning the geometric structure of the interdigital capacitor along a first direction and a direction vertical to the first direction, wherein the first direction is vertical to an extension direction of the end of the cross-shaped structure inserted into the groove of the U-shaped structure.

9. The electronic device of claim 6, wherein the parameter value of the dimension parameter to be optimized is optimized using a gradient descent method, to minimize the loss function.

10. The electronic device of claim 6, wherein the capacitance value expression of the interdigital capacitor is obtained by determining respective capacitance values of the plurality of coplanar multiple transmission line models, and wherein the capacitance value of at least one of the plurality of coplanar multiple transmission line models is determined based on a conformal transformation method.

11. A non-transitory computer-readable storage medium that stores one or more programs comprising instructions that, when executed by one or more processors of a computing device, cause the computing device to implement operations comprising:
obtaining a parameter value of a determined dimension parameter, an initial parameter value of a dimension parameter to be optimized, and a target capacitance value of an interdigital capacitor;
partitioning a geometric structure of the interdigital capacitor to obtain a plurality of sections of the interdigital capacitor, wherein the plurality of sections are in a one-to-one correspondence with a plurality of coplanar multiple-transmission line models;
obtaining a capacitance value expression of the interdigital capacitor based on the plurality of coplanar multiple-transmission line models;
determining, based on the parameter value of the determined dimension parameter, the target capacitance value of the interdigital capacitor, and the capacitance value expression of the interdigital capacitor, a loss function including the dimension parameter to be optimized; and
optimizing, based on the initial parameter value of the dimension parameter and by minimizing the loss function, the parameter value of the dimension parameter to be optimized, to obtain an optimized parameter value of the dimension parameter to be optimized.

12. The non-transitory computer-readable storage medium of claim 11, wherein the interdigital capacitor comprises a U-shaped structure and a cross-shaped structure, with an end of the cross-shaped structure inserted into a groove of the U-shaped structure, and wherein
the determined dimension parameter comprises at least one of a width of a center conductor of the U-shaped structure, a width of a center conductor of the cross-shaped structure, a distance between the U-shaped structure and the end of the cross-shaped structure inserted into the U-shaped structure, and respective etching widths for forming the U-shaped structure and the cross-shaped structure through etching; and
the dimension parameter to be optimized comprises a depth of the groove of the U-shaped structure.

13. The non-transitory computer-readable storage medium of claim 11, wherein the interdigital capacitor comprises a U-shaped structure and a cross-shaped structure, with an end of the cross-shaped structure inserted into a groove of the U-shaped structure, and wherein
the plurality of sections of the interdigital capacitor are obtained by partitioning the geometric structure of the interdigital capacitor along a first direction and a direction vertical to the first direction, wherein the first direction is vertical to an extension direction of the end of the cross-shaped structure inserted into the groove of the U-shaped structure.

14. The non-transitory computer-readable storage medium of claim 11, wherein the parameter value of the dimension parameter to be optimized is optimized using a gradient descent method, to minimize the loss function.

15. The non-transitory computer-readable storage medium of claim 11, wherein the capacitance value expression of the interdigital capacitor is obtained by determining respective capacitance values of the plurality of coplanar multiple transmission line models, and wherein the capacitance value of at least one of the plurality of coplanar multiple transmission line models is determined based on a conformal transformation method.
